(19) United States
(12) Patent Application Publication
(10) Pub. No.: US 2002/0127933 A1
(43) Pub. Date: Sep. 12, 2002

(54) Membrane roofing sheet

(75) Inventors: Gerard Baccus, Accons (FR); Philippe Sanial, Le Cheylard (FR); Bruno Cledat, Le Cheylard (FR)

Correspondence Address: Mary Louise Gioeni, Heslin Rothenberg Farley & Mesiti P.C., 5 Columbia Circle, Albany, NY, 12203, US

(73) Assignee: Textiles Et Plastiques Chomarat, Le Cheylard (FR)

(21) Appl. No.: 10/059,562

(22) Filed: Jan. 29, 2002

Related U.S. Application Data
(63) Continuation of application No. PCT/FR00/01993, filed on Jul. 11, 2000.

(30) Foreign Application Priority Data
Jul. 30, 1999 (FR) FR/99.10146

(51) Int. Cl. B32B 5/02; B32B 27/04

(52) U.S. Cl. 442/86; 442/290; 428/294.7

(57) ABSTRACT

The invention concerns a material for producing built-up roofing, comprising a textile support (T) covered, on one of its faces, with a surface layer (4) closely bound thereto, and consisting of a synthetic resin, said surface layer (4) being based on thermoplastic resins selected from the family of polyolefins, capable of being produced in sheet. The invention is characterized in that said surface layer (4) is based on ethylene polymers or copolymers, its combination with the textile support (T) being obtained by calendering, the latter being embedded over part of its thickness inside the resin layer (4).

### TECHNICAL FIELD

The present invention relates to a novel type of material that can be used for the production of membrane roofing sheets, especially in the building field, which provide not only the waterproofing but also the insulation of roofs, said material being commonly known in this technical sector by the name “roofing”.

### PRIOR ART

At the present time, there are two broad types of material used to produce membrane roofing sheets.

The most widely used type consists of bitumen-based roofing comprising a reinforcing structure embedded in the bitumen composition, giving the assembly the mechanical properties, the dimensional stability and the puncture resistance, both static and dynamic, that such roofing must have.

The general structure of such materials is clearly described, for example, in patents U.S. Pat. Nos. 3,193,439 and 3,937,640. In general, this roofing at the present time is laid over the structure to be covered using what is called the “monolayer” technique, by unrolling continuous sheets, the length of which may be up to several tens of meters and the width of which is in general between 0.50 m and 2 m, and fastening them to the surface of the structure, it being possible for the fastening to be performed either mechanically, or by heating the bitumen composition, or else by having a self-adhesive bitumen composition or a cold-setting adhesive.

In all cases, the join between two consecutive sheets entails making a weld at this point either by hot air or by flame heating.

Apart from this type of material, it has also been proposed to use membranes made from a synthetic polymer, in general one based on polyvinyl chloride and sometimes based on an elastomer of the ethylenepropylene-diene monomer (EPDM) terpolymer type or any other equivalent composition.

Such roofing has the advantage that the surface appearance, and especially the color, can be varied at will.

However, compared with bitumen-based membranes, such products are very expensive.

It has also been proposed, as disclosed in U.S. Pat. No. 4,457,983, to produce a complex for impervious roofing sheets, which comprises a top layer consisting of a sheet of thermoplastic resin, chosen from the family of polyolefins (EVA), combined with a fibrous intermediate layer, such as a nonwoven, and with an underlayer consisting of a conventional asphalt sheet.

### SUMMARY OF THE INVENTION

An improvement to the type of complex material that can be used for producing impervious roofing sheets, such as those described in the aforementioned patent U.S. Pat. No. 4,457,983, which improves the properties exhibited by such a material, has now been found, and it is this which forms the subject of the present invention.

This is because the novel material according to the invention has both the advantages provided by membranes produced from a synthetic polymer, namely appearance, coloration, resistance to chemical and industrial attack, resistance to ultraviolet radiation and the possibility of embossing the product, and those of bitumen-based membranes, namely mechanical strength properties, dynamic and static puncture resistance and ease of laying.

In general, the material according to the invention, which therefore allows such membrane roofing sheets to be produced, comprises a textile backing (T) covered, on one of its sides, with a top layer intimately bonded to the latter and consisting of a synthetic resin, said top layer being based on thermoplastic resins, chosen from the polyolefin family, which can be made in sheet form.

The material according to the invention is characterized in that said top layer is more particularly based on ethylene polymers or copolymers, it being combined with the textile backing by calendering, this backing being embedded over part of its thickness within the resin layer.

According to one embodiment, the top layer based on a synthetic polymer extends over the entire width of the textile backing.

Moreover, according to a preferred embodiment, a textile tape consisting of a nonwoven, preferably a nonwoven consisting of continuous filaments produced according to the known spinning/drawing/web-forming technique called “spunbond”, is provided along one edge of the complex, attached to the resin layer and bonded by the latter over a width lying in general between 10 and 20 cm.

Such a structure makes it easier, when producing the roofing on site, to weld together two consecutive sheets at their join.

According to a first embodiment in accordance with the invention, the bitumen impregnation is carried out in such a way that the textile backing is embedded within the bitumen composition.

According to a variant, before bitumen impregnation, an aluminum foil is attached to the reverse side of the complex, that is to say to the surface of the textile backing, said aluminum foil being fastened to this side by adhesive bonding and the bitumen-based composition being attached to the aluminum surface and therefore not penetrating into the fibrous structure.

The incorporation of such an aluminum foil into the complex, such an incorporation being known for a long time for producing roof coverings as disclosed in French patent 1 205 703 and patent U.S. Pat. No. 4,287,248, offers additional advantages, among which mention may be made of improved insulation and above all improved impermeability, preventing the migration of plasticizers from the bitumen into the top layer.

When the complex includes a lateral reinforcement partly embedded into the top coating, said reinforcement serves as an interface for tying to the bitumen, when the latter impregnates the textile structure, and also fulfills the role of protection during flame bonding.

The textile backing, used to produce a complex according to the invention, will consist of any structure that can be used in the field of membrane reinforcements, as described in French patent 2 562 471 and patents EP 160 609, EP 285 533 and EP 315 553, and in general will include at least one fibrous web combined with a textile mesh, it being possible for the nature of the constituents of the fibrous structure and of the reinforcing mesh to be based on glass and/or on a synthetic polymer, such as a polyester, polyamide, polyvinyl acetate or polypropylene.

Such a complex will be obtained in accordance with the teachings of the aforementioned patents by bonding (FR 2 562 471), mechanical needle bonding (EP 160 609) or a fluid-jet treatment (EP 285 533 and 315 553).

In practice, the top layers based on synthetic resins will have a thickness of between 0.5 mm and 2 mm, the textile backing itself having a thickness of 0.2 mm to 1.5 mm and weighing between 30 g/m² and 500 g/m².

The textile backing/film combination is produced by calendering immediately downstream of a unit extruding the polymer.

Such a combination is produced in accordance with the teachings of patent EP 208 627 using a calender comprising a metal roll (which is smooth or embossed) and a roll coated with a layer of siliconized rubber.

This combining operation is carried out immediately downstream of the exit of the die for extruding the film, while the latter is still at a high temperature of around 170 to 180° C. in the case of a polyethylene-based film.

Such a way of carrying out the process therefore allows a structure as is disclosed in EP 208 627 to be obtained, in such a way that the resin penetrates only partially into the thickness of the textile backing, thus allowing the operation of impregnating with the bitumen composition to be carried out during a subsequent operating phase, although it may be envisioned to carry out said operation directly and continuously, downstream of the complexing unit.

In a variant in accordance with the invention, in which a metal foil, for example crumpled or hammered aluminum, is attached to the reverse side of the textile backing, this foil may be attached either during an operation prior to the operation of complexing the top layer or during this complexing operation.

### BRIEF DESCRIPTION OF THE DRAWINGS

The invention and the advantages that it provides will, however, be more clearly understood thanks to the example embodiments which follow and which are illustrated by the appended drawings, in which:

FIG. 1 is a schematic perspective view of a complex according to the invention, which can be used to produce a membrane roofing sheet;

FIG. 2 illustrates, schematically, the way in which the operation of laying the membrane sheet is carried out; and

FIG. 3 is a schematic perspective view illustrating the technique for producing the complex.

### MANNER IN WHICH THE INVENTION IS REALIZED

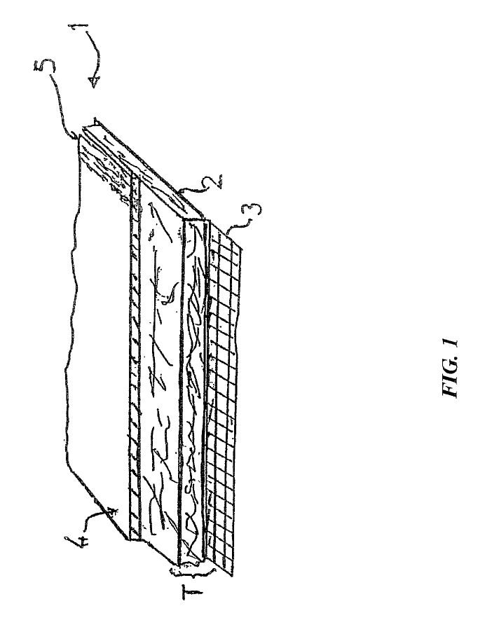

Referring to the appended figures, and more particularly to FIG. 1, the material according to the invention, which is used to produce membrane roofing, comprises, on the one hand, a textile backing (T) intended to be subsequently embedded in a bitumen composition, said textile backing (T) comprising at least one nonwoven fibrous web (2) combined with a reinforcement (3), such as especially a woven or nonwoven mesh.

Optionally, the reinforcing structure (3) may also be covered with a second fibrous web, the various layers being bonded together by any appropriate means, such as adhesive bonding, stitch bonding, conventional needle bonding or fluid-jet treatment (water-jet bonding).

Optionally, in one embodiment, the textile backing (T) may be combined with a thin metal foil, for example an aluminum film, which can be deposited either against the reverse side of the textile structure (T) or optionally embedded in the latter, for example between the reinforcing mesh (3) and the textile structure (2).

This textile backing (T) is combined with a top layer (4) intended to form the top layer of the roofing after it has been laid on site. This top layer (4) is produced from thermoplastic resins which can be made in the form of sheets, these being chosen from the polyolefin family and more particularly being based on ethylene polymers or copolymers exhibiting very good resistance to ultraviolet radiation and chemical attack.

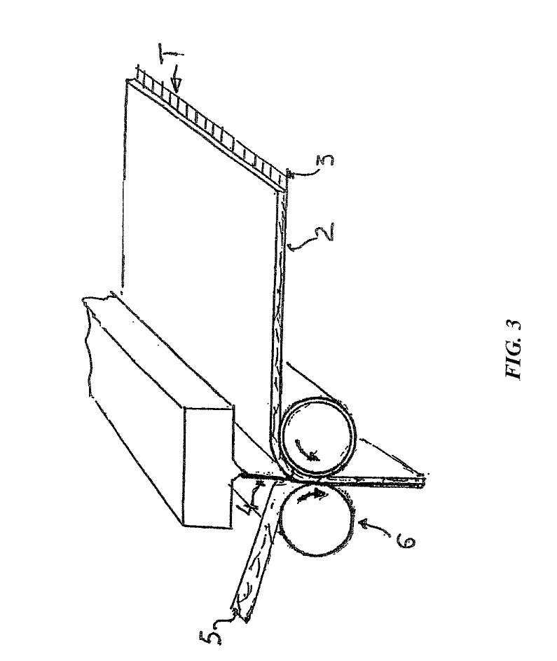

The top layer (4) is combined with the textile backing (T) by calendering (see FIG. 3), the textile backing (T) being embedded over part of its thickness within the resin layer during this calendering operation.

Advantageously, in order to make it easier for two consecutive sheets to be subsequently joined together, after they have been laid on the area to be protected, a lateral reinforcement (5) is embedded in the top coating (4). Such a reinforcement advantageously consists of a nonwoven of the “spunbond” type combined with the resin layer (4) during the complexing operation, by being fed onto the smooth roll (6) of the calender.

In general, in accordance with the invention, the top layer (4) has a thickness of between 0.2 mm and 1.2 mm.

After production, and continuously with the operation of producing the complex or during a separate operating phase, the fibrous structure is impregnated with a bitumen-based composition, the impregnation being carried out at a temperature of around 180° C. The top layer (4) is not damaged, the fibrous structure acting as a thermal barrier.

When the textile structure (T) has, on its reverse side, a thin metal foil, the bitumen-based composition is deposited on the surface of this metal foil and adheres to the latter.

The reinforced textile backing will, as mentioned above, consist of a nonwoven combined with a reinforcement such as a mesh. Advantageously, the constituents of this nonwoven and of the mesh will be glass fibers.

To improve the puncture resistance, it may be envisioned to use a glass/polyester web complex, the polyester fibers being, however, trapped within the glass layers.

The glass mesh provides dimensional stability, mechanical properties, puncture resistance and resistance to loads.

The felt, preferably glass felt, serves as an interface for the bitumen-impregnated sides, provides thermal stability during this impregnation and also forms a barrier to any plasticizer that the bitumen contains, so that it does not get into the surface coating.

Optionally, this nonwoven structure, which advantageously is made of glass, may include fibers or a chemical coating of the same nature as the surface coating which favor the mutual fastening and adhesion of the products.

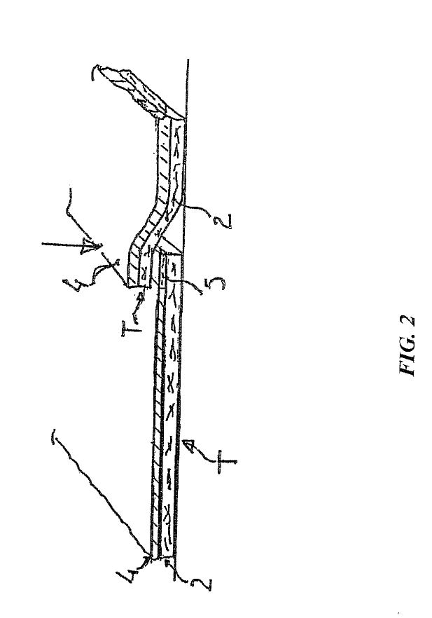

Finally, with regard to installation, the presence of a nonwoven tape along one of the edges of the complex serves as mechanical reinforcement when two consecutive sheets are overlapped as illustrated in FIG. 2.

The overlap thus produced provides a perfect seal between two consecutive sheets and eliminates any risk of water filtration.

### EXAMPLE 1

A structure (T) was produced which comprised, as textile backing (T), a nonwoven web (2) consisting of a glass felt weighing 35 g/m² and coated on its underside with a mesh, also consisting of glass yarns, the apertures in this mesh having sides of 0.5 cm. This mesh was simply adhesively bonded to the reverse side of the felt (2).

The complex (T) was combined with a film, obtained from a polyolefin composition, at a temperature of 180° C. in a plant like that illustrated in FIG. 3.

A tape (5) 10 cm in width, consisting of a “spunbond”-type glass nonwoven, was attached laterally to the reverse side of the extruded film, in contact with the roll (6) of the calender.

After calendering, a complex was obtained whose various layers were perfectly bonded together. This complex was then coated, on its textile side, with a bitumen composition deposited in an amount of 3500 g/m². After bitumen impregnation, the assembly had a thickness of 4 mm.

### EXAMPLE 2

Example 1 was repeated, except that the structure (T) had two polyester felts placed on either side of the textile mesh (3), the layers being needle-bonded together by means of fluid jets.

After complexing with a film (4) similar to example 1, a structure was obtained whose fibrous mass was able to be impregnated with a bitumen composition without any deterioration in the appearance and the properties of the top layer consisting of the synthetic resin.

### EXAMPLE 3

Examples 1 and 2 were repeated, except that the structure (T) was combined with a preferably hammered aluminum foil, this aluminum foil being placed either directly against the textile reinforcing mesh (3) or interposed between the textile reinforcing mesh (3) and the felt (2).

This metal foil was combined with the structure (T), for example by adhesive bonding.

In such an embodiment, the bitumen composition was attached to the aluminum surface and therefore did not penetrate the core of the fibrous structure.

Such an embodiment, which is more expensive and more complex than that produced by examples 1 and 2, has the advantage of improving the resistance to migration of the binders out of the bitumen, while preventing any damage to the top layer (4).

Compared with the prior solutions, the material according to the invention has many advantages because it possesses both the characteristics of bitumen-based roofing membranes and those of membranes made from a synthetic polymer, and more particularly the appearance and the decoration that such membranes allow to be obtained, while still having a reasonable production cost.

Of course, the invention is not limited to the embodiments described above, rather it encompasses all variants thereof made within the same spirit.

1. A material for producing membrane roofing sheets, comprising a textile backing (T) covered, on one of its sides, with a top layer (4) intimately bonded to the latter and consisting of a synthetic resin, said top layer (4) being based on thermoplastic resins, chosen from the polyolefin family, which can be made in sheet form, characterized in that:
Said top layer (4) is based on ethylene polymers or copolymers, it being combined with the textile backing (T) by calendering, this backing being embedded over part of its thickness within the resin layer (4);
it comprises a unic layer of bitumen composition located on the side of the support backing opposite to said top layer.

2. The material as claimed in claim 1, characterized in that the textile backing (T) is subsequently embedded in a bitumen composition.

3. The material as claimed in claim 1, characterized in that the textile backing is combined on its reverse side with a thin metal (aluminum) foil, the bitumen composition being attached to this metal foil.

4. The material as claimed in one of claims 1 to 3, characterized in that the top layer (4) extends over the entire width of the textile backing (T), a textile tape (5) consisting of a nonwoven being attached to the resin layer along one edge of the complex and being bonded by the resin layer.

5. The material as claimed in either of claims 1 and 2, characterized in that the textile backing (T) comprises at least one fibrous web (2) combined with a textile mesh (3) based on glass and/or on a synthetic polymer, such as a polyester, polyamide, polyvinyl acetate or polypropylene.
